(19) United States
(12) Patent Application Publication
(10) Pub. No.: US 2025/0279674 A1
(43) Pub. Date: Sep. 4, 2025

(54) SIMULTANEOUS COMMISSIONING OF A PLURALITY OF SMART CIRCUIT BREAKERS IN A POWER DISTRIBUTION SYSTEM

(71) Applicant: EATON INTELLIGENT POWER LIMITED, DUBLIN 4 (IE)

(72) Inventors: Narayanaswamy Ramakrishnan, Pune (IN); Nitin Bhosale, Pune (IN); Rahul S. Sakhare, Pune (IN); Rahul Vageriya, Pune (IN)

(73) Assignee: EATON INTELLIGENT POWER LIMITED, DUBLIN 4 (IE)

(21) Appl. No.: 18/594,120

(22) Filed: Mar. 4, 2024

(51) Int. Cl. H02J 13/00; G16Y 30/00; H04W 12/06; H04W 84/12

(52) U.S. Cl. CPC H02J 13/00026; G16Y 30/00; H02J 13/0004; H04W 12/06; H04W 84/12

(57) ABSTRACT

A method of simultaneously commissioning a plurality of smart circuit breakers to an energy control website in an IoT Hub in a cloud is provided. Each smart circuit breaker is structured to be coupled to a power source and respective load and provide circuit protection in a fault event. The method includes: forming, by the plurality of smart circuit breakers, a Wi-Fi network; commissioning a master smart circuit breaker to the energy control website in the IoT Hub via a mobile energy control application disposed in a mobile user device; simultaneously commissioning slave smart circuit breakers to the energy control website in the cloud via the mobile energy control application and the master smart circuit breaker; and connecting the master smart circuit breaker and the slave smart circuit breakers to the IoT Hub via an access point.

### FIELD OF THE INVENTION

The disclosed concept relates generally to a system and method of securely executing commands via a cloud server, and in particular, to a system and method of simultaneous commissioning of a plurality of smart circuit breakers in a power distribution system.

### BACKGROUND OF THE INVENTION

Cloud computing shares computing resources that are generally accessed via the Internet. Particularly, its infrastructure allows user to access a shared pool of computing resources, such as servers, storage devices, networks, applications, and/or other computing-based services. As such, the users and clients can remotely access computing resources on demand. IoT (Internet of Things) or edge IoT devices are physical electronic devices that are connected to a communication network, e.g., LAN, WAN, etc. and may be configured to transmit and receive information via the network. IoT devices can access cloud computing services or interact with an application via cloud servers and the network. IoT devices may be stationary, e.g., home appliance or manufacturing equipment, or mobile, e.g., cellular phones, vehicles accessories, etc. More and more devices are becoming IoT devices in consumer, industrial, energy, transportation, military and other fields.

However, as the IoT devices proliferate, issues rise with such proliferation. For example, many smart devices are configured with different set-up procedures (i.e., commission or provisioning procedures) depending on the type of the devices, capabilities of the devices or communication protocol employed by the devices. In general, one-to-one commissioning per device is required for the smart devices to be registered with the IoT Hub 16. For example, when commissioning smart circuit breakers in a power distribution system, e.g., without limitation, one or more load centers, each smart circuit breaker undergoes one-to-one Wi-Fi commissioning with the IoT Hub 16 via a SoftAP (software enabled access point) and/or Bluetooth® Low Energy (BLE) Radio.

FIG. 3 illustrates the current one-to-one commissioning procedure for smart circuit breakers 1a-1n installed in a power distribution system, where n is an integer. The one-to-one procedure includes five steps. At step 1, a first smart circuit breaker 1a enters BLE mode and a mobile energy control application scans the first smart circuit breaker 1a. In order to enter the BLE mode, a user actuates a switch or button 2a-2n on a smart circuit breaker 1a-1n. Upon actuating a switch 2a on a first smart circuit breaker 1a, the mobile energy control application start to scan its detection area (e.g., without limitation, 2-5 meters). At step 2, upon locating the first smart circuit breaker 1a, the mobile energy control application 11 receives device ID of the first smart circuit breaker 1a. The mobile energy control application 11 becomes paired to the first smart circuit breaker 1a and authenticates the first smart circuit breaker 1a via the BLE connection 4. At step 3, the mobile energy control application transmits Wi-Fi credentials for an access point (AP) 14 to the first smart circuit breaker 1a via the BLE connection 4. The first smart circuit breaker 1a in turn scans the Wi-Fi APs in the vicinity and transmits a list of the Wi-Fi APs to the mobile energy control application over the BLE connection 4. The Wi-Fi APs appear on the mobile energy control application and the user selects the SSID of the AP 14 and enters a corresponding Wi-Fi credentials such as a password for the AP 14 into the mobile energy control application. Upon validation of the Wi-Fi credentials, the mobile energy control application is connected to the AP 14 and commissions the first smart circuit breaker 1a to the energy control website in the cloud 5. The mobile energy control application registers the first smart circuit breaker 1a and configures the first smart circuit breaker 1a (e.g., without limitation, provide a name to the first smart circuit breaker 1a, etc.). At Step 4, the first smart circuit breaker 1a become indirectly connected to the IoT Hub 16 via the AP 14 and the user monitors the first smart circuit breaker 1a via the mobile energy control application. That is, the mobile energy control application uses the ID device address of the first smart circuit breaker 1a and connects the first smart circuit breaker 1a to the AP 14. The AP 14 in turn connects the first smart circuit breaker 1a via Ethernet to the IoT Hub 16. The mobile energy control application then disconnects the BLE connection 4 with the first smart circuit breaker 1a. At step 5, each of remaining smart circuit breakers 1b-1n undergoes the one-on-one commissioning procedure by repeating the Steps 1-4. The user can then monitor and control the smart circuit breakers 1a-1n within the power distribution system remotely via the mobile energy control application.

However, such one-on-one commissioning is not only time consuming, but also very costly, especially when the power distribution system includes a large number of smart circuit breakers to be commissioned.

There is room for improvement in commissioning IoT devices to IoT Hubs.

### SUMMARY OF THE INVENTION

A method of simultaneously commissioning a plurality of smart circuit breakers to an energy control website in an IoT (Internet-of-Things) Hub in a cloud is provided. Each smart circuit breaker is structured to be coupled to a power source and respective load and provide circuit protection in a fault event. The method includes forming, by the plurality of smart circuit breakers, a Wi-Fi network, each smart circuit breaker being capable of acting as a master smart circuit breaker; commissioning a master smart circuit breaker to the energy control website in the IoT Hub via a mobile energy control application disposed in a mobile user device; simultaneously commissioning slave smart circuit breakers to the energy control website in the cloud via the mobile energy control application and the master smart circuit breaker; and connecting the master smart circuit breaker and the slave smart circuit breakers to the IoT Hub via an access point (AP).

Another example embodiment provides a method of automatically commissioning a replacement smart circuit breaker in a Wi-Fi network including a plurality of smart circuit breakers structured to be coupled to a power source and respective loads and provide circuit protection in a fault event. The plurality of smart circuit breakers have been commissioned simultaneously to an energy control website in an IoT Hub in a cloud upon forming the Wi-Fi network. The method includes: determining that the Wi-Fi network includes a faulty smart circuit breaker; in response to the determination that the Wi-Fi network includes a faulty smart circuit breaker, installing a replacement smart circuit breaker for the faulty smart circuit breaker; selecting a master smart circuit breaker from the commissioned smart circuit breakers and actuating the master smart circuit breaker; initiating, by the master smart circuit breaker, the automatic commissioning of the replacement smart circuit breaker; authenticating, by the replacement smart circuit breaker, the master smart circuit breaker and transmitting a device ID thereof to the master smart circuit breaker; transmitting, by the master smart circuit breaker, Wi-Fi credentials for an access point for the Wi-Fi network; authenticating, by the replacement smart circuit breaker, the Wi-Fi credentials; and connecting, by the replacement smart circuit breaker, to the AP and to the energy control website in the IoT using the Wi-Fi credentials.

Yet another example embodiment provides a system. The system includes a plurality of smart circuit breakers structured to be coupled to a power source and respective loads and provide circuit protection during a fault event; a mobile energy control application disposed in a mobile user device; an IoT Hub disposed in the cloud and communicatively coupled to the mobile energy control application, the IoT Hub including the energy control website; and an AP structured to be connected to the plurality of smart circuit breakers and the IoT Hub, wherein the plurality of smart circuit breakers are commissioned to the energy control website using a simultaneous Wi-Fi commissioning procedure. The simultaneous Wi-Fi commissioning procedure includes: forming, by the plurality of smart circuit breakers, a Wi-Fi network, each smart circuit breaker being capable of acting as a master smart circuit breaker; commissioning a master smart circuit breaker to the energy control website in the IoT Hub via the mobile energy control application; simultaneously commissioning slave smart circuit breakers to the energy control website via the mobile energy control application and the master smart circuit breaker; and connecting the master smart circuit breaker and the slave smart circuit breakers to the AP and to the energy control website in the IoT Hub via the AP.

### BRIEF DESCRIPTION OF THE DRAWINGS

A full understanding of the invention can be gained from the following description of the preferred embodiments when read in conjunction with the accompanying drawings in which:

FIG. 1 is a diagram of an exemplary system including a plurality of smart circuit breakers connected to an access point and a cloud in accordance with a non-limiting embodiment of the disclosed concept;

FIG. 2 is a sequential diagram that illustrates a method of simultaneously commissioning a plurality of smart circuit breakers in a Wi-Fi network in accordance with a non-limiting embodiment of the disclosed concept;

FIG. 3 is a sequential diagram that illustrates a conventional method of one-to-one commissioning of a plurality of smart circuit breakers;

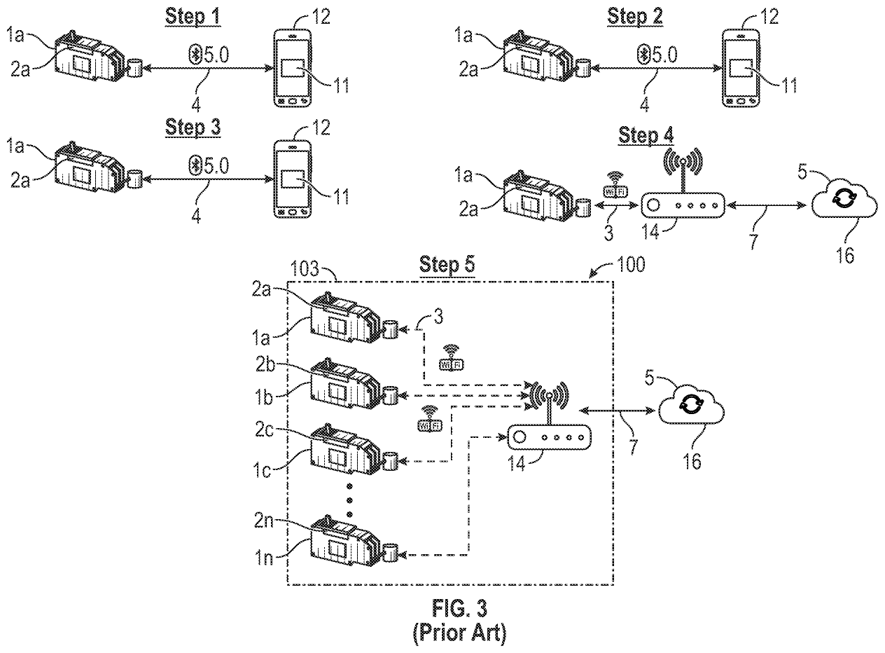

FIG. 4A illustrates Step 1 of the method of simultaneously commissioning of FIG. 2. At Step 1 sets forth a process of forming a Wi-Fi network of a plurality of smart circuit breakers to be simultaneously commissioned to an IoT Hub in accordance with a non-limiting embodiment of the disclosed concept;

FIG. 4B illustrates Step 2 of the method of simultaneously commissioning of FIG. 2. At Step 2, a master smart circuit breaker is commissioned to an energy control website in the cloud in accordance with a non-limiting embodiment of the disclosed concept;

FIG. 4C illustrates Step 3 of the method of simultaneously commissioning of FIG. 2. At Step 3, the slave smart circuit breakers are simultaneously commissioned to the energy control website in the cloud in accordance with a non-limiting embodiment of the disclosed concept;

FIG. 4D illustrates Step 4 of the method of simultaneously commissioning of FIG. 2. At Step 4, all of the smart circuit breakers in the Wi-Fi network is connected to the IoT Hub via the AP in accordance with a non-limiting embodiment of the disclosed concept;

FIG. 5 is a flow chart for a method of simultaneously commissioning a plurality of smart circuit breakers in a Wi-Fi network in accordance with a non-limiting embodiment of the disclosed concept; and

FIG. 6 is a flow-chart for a method of replacing a faulty smart circuit breaker in the Wi-Fi network of FIG. 2 and commissioning a replacement smart circuit breaker in the Wi-Fi network in accordance with a non-limiting embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

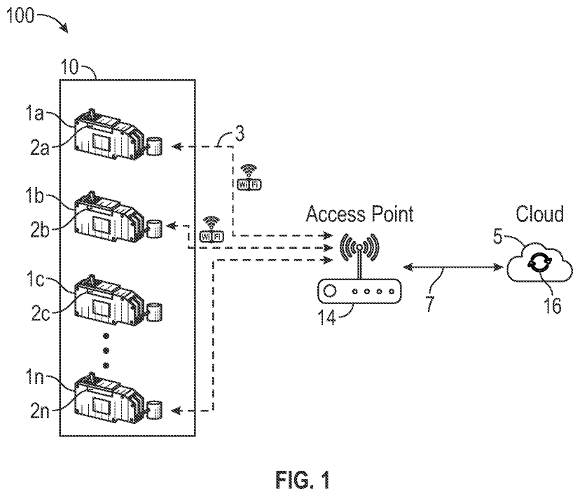

FIGS. 1, 2, 4A-D and 5 illustrate a power system 100 including a plurality of smart circuit breakers 1a-1n and a method 400,500 of simultaneously (substantially simultaneously) commissioning the plurality of smart circuit breakers 1a-1n to an energy control website stored in the cloud 5 via a mobile energy control application 11 in accordance with a non-limiting embodiment of the disclosed concept. The plurality of smart circuit breakers 1a-1n may be installed in a power distribution system, e.g., without limitation, a load center 10. The power system 100 may include a plurality of load centers 10, each load center including a plurality of smart circuit breakers and associated with a single access point (AP) 14 or its own AP within respective Wi-Fi range (e.g., without limitation, 4-5 meters). The smart circuit breakers 1a-1n are standard circuit breakers 1a-1n structured to be coupled to a power source and a load and provide circuit protection during a fault event. The smart circuit breakers 1a-1n can be remotely controlled via a mobile energy control application 11 installed in a mobile user device 12. The smart circuit breakers 1a-1n form a Wi-Fi network 103 using a wireless communication protocol such as ESP-NOW protocol. The ESP-NOW protocol is defined by Espressif and enables a direct and low-power control of IoT devices without using a router. The smart circuit breakers 1a-1n then are simultaneously commissioned to the energy control website via the Wi-Fi connection 3.

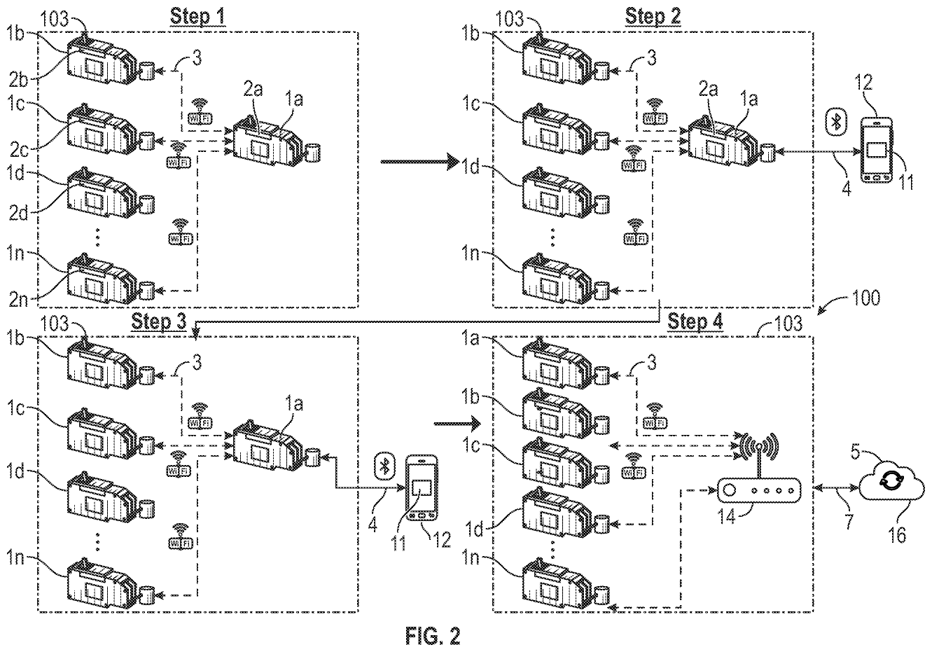

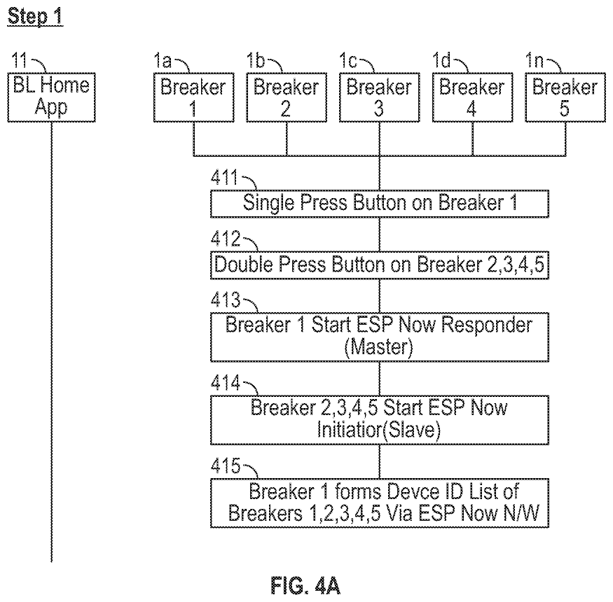

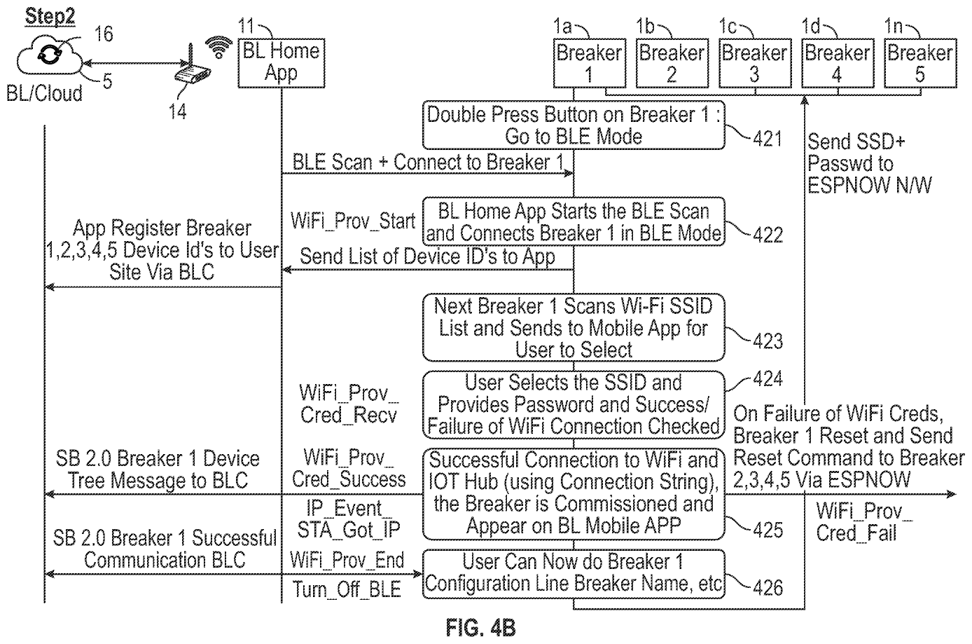

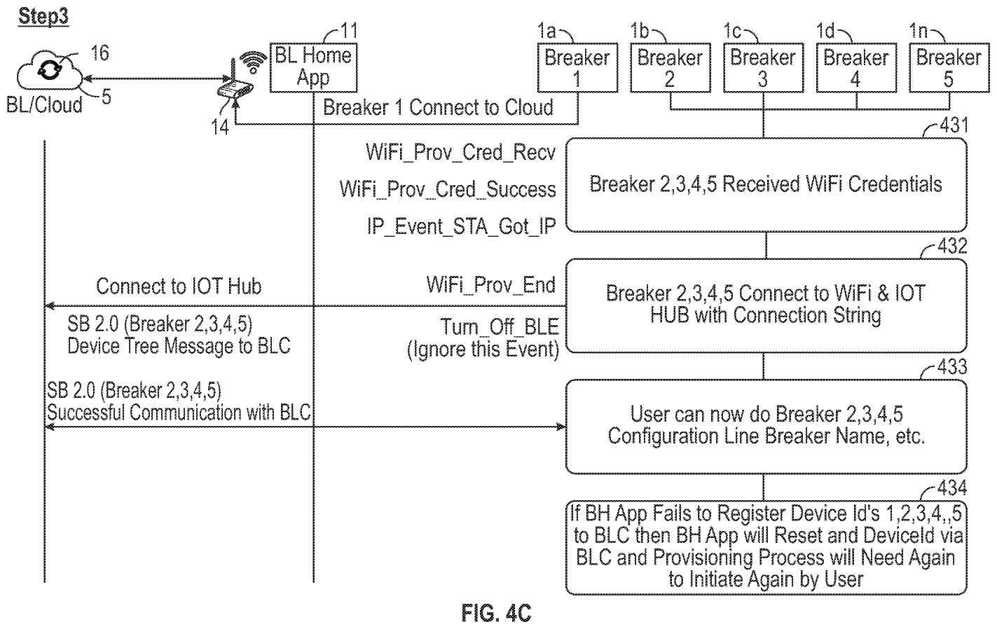

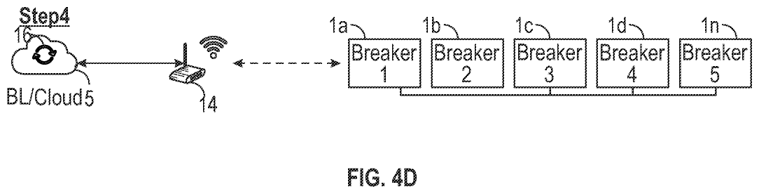

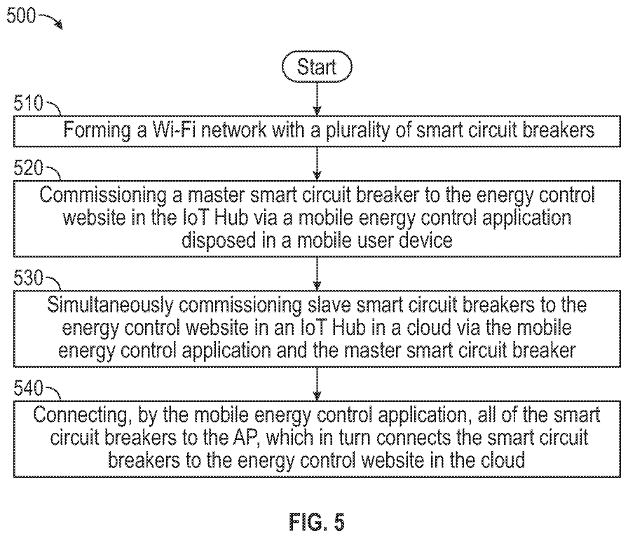

As shown in FIGS. 2, 4A-D and 5, the simultaneous commissioning procedure of the plurality of smart circuit breakers 1a-1n consists of four steps. As described with reference to FIG. 5, the four steps include: forming, by the plurality of smart circuit breakers 1a-1n, the Wi-Fi network 103, each smart circuit breaker 1a-1n being capable of acting as a master smart circuit breaker; commissioning a master smart circuit breaker 1a to the energy control website in the IoT Hub 16 via the mobile energy control application 11 disposed in the mobile user device 12; simultaneously commissioning slave smart circuit breakers 1b-1n to the energy control website in the cloud 5 via the mobile energy control application 11 and the master smart circuit breaker 1a; and connecting the master smart circuit breaker 1a and the slave smart circuit breakers 1b-1n to the IoT Hub 16 via the AP 14.

FIGS. 4A-D provide detailed sub-steps for each of the four steps. The detailed sub-steps of each broader step are provided below with reference to FIGS. 2 and 4A-D. While the master smart circuit breaker 1a and the slave smart circuit breakers 1b-1n are commissioned substantially simultaneously, the simultaneous commissioning procedure includes simultaneous commissioning of slave smart circuit breakers 1b-1n without having to undergo one-to-one commissioning currently required by the conventional commissioning procedure. That is, all of the slave smart circuit breakers 1b-1n is commissioned at the same time, not one by one as currently required by the conventional commissioning procedure.

At Step 1, the plurality of smart circuit breakers 1a-1n form a Wi-Fi network 103. Forming the Wi-Fi network 103 includes installing the plurality of smart circuit breakers in a power distribution system; actuating a switch on one smart circuit breaker to commence a Wi-Fi network forming procedure; transmitting, by the one smart circuit breaker, a request to connect; actuating switches on remaining smart circuit breakers; transmitting, by the remaining smart circuit breakers, responses to the one smart circuit breaker; and forming, by the one smart circuit breaker and the remaining smart circuit breakers, the Wi-Fi network based on the responses All of the smart circuit breakers 1a-1n has been installed in the load center 10 and is in a secondary mode (a slave mode). Each smart circuit breaker 1a-1n includes a switch 2a-2n and upon actuation of the switches 2a-2n, the smart circuit breakers 1a-1n form a wireless communication connection, e.g., without limitation, a Wi-Fi connection, a Bluetooth® Low Energy (BLE) connection, etc. The switch 2a-2n may use the ESP-NOW protocol, which coexists with the Wi-Fi and BLE protocols. To form the Wi-Fi Network 103, a user actuates the switch 2a-2n on one smart circuit breaker 1a-1n at 411. Upon actuation of the switch 2a-2n, the first smart circuit breaker 1a-1n is placed in a primary mode and acts as a master smart circuit breaker in ESP-NOW pairing (e.g., without limitation, one-to-many). At 412, the user promptly actuates the switches 2a-2n on the remaining smart circuit breakers 2a-2n. At 413, the one smart circuit breaker 1a-1n starts an ESP NOW responder. At 414, the remaining smart circuit breakers 1a-1n start an ESP-Now initiator as slave devices. Upon the ESP-NOW pairing, the smart circuit breakers 1a-1n form the Wi-Fi network 103 using the ESP-NOW protocol. Upon forming the Wi-Fi network 103, the remaining smart circuit breakers 1a-1n transmit MAC (media-access-controller) address including device IDs (UUID (universal unique individual identifier)) to the one smart circuit breaker 1a-1n over the Wi-Fi connection 3. At 415, the one smart circuit breaker 1a-1n then creates a device ID list of all of the smart circuit breakers 1a-1n within the Wi-Fi network 103.

At Step 2, a user selects any one of the smart circuit breakers 1a-1n to act as the master smart circuit breaker 1a and the master smart circuit breaker 1a is commissioned to the energy control website in the IoT Hub 16. The commissioning the master smart circuit breaker 1a includes: selecting a smart circuit breaker 1a to act as the master smart circuit breaker; actuating a switch on the master smart circuit breaker 1a and placing the master smart circuit breaker 1a in a Bluetooth Low Energy (BLE) mode; scanning, by the mobile energy control application 11, for presence of smart circuit breakers 1a-1n in detection range thereof in the BLE mode; connecting, by the mobile energy control application 11, to the master smart circuit breaker 1a via the BLE connection 4; authenticating Wi-Fi credentials of the AP 14; connecting, by the mobile energy control application 11, the energy control website in the IoT Hub 16 to the AP 14 based on the authentication; determining, by the mobile energy control application 11, that the energy control website in the IoT Hub 14 is successfully connected to the AP 14; and commissioning the master smart circuit breaker 1a based on the determination that of the energy control website in the IoT Hub 16 is successfully connected to the AP 14. Step 2 includes sub-steps 421-426.

At 421, the user actuates the switch 2a of the master smart circuit breaker 1a and places the master smart circuit breaker 1a in a BLE mode. At 422, the mobile energy control application 11 scans using a BLE radio and becomes paired with the master smart circuit breaker 1a. At 423, the master smart circuit breaker 1a scans Wi-Fi APs in vicinity thereof, creates a list of the Wi-Fi APs, and transmits the list of the Wi-Fi APs to the mobile energy control application 1. The master smart circuit device 1a may also transmit a device ID list of all of the smart circuit breakers 1a-1n within the Wi-Fi network 103 to the mobile energy control application 11. The Wi-Fi APs in the vicinity appear on the mobile energy control application 11. At 424, the user authenticates the Wi-Fi credentials of the AP 14. That is, the user selects an SSID (service set identifier) of the AP 14 and enters, e.g., without limitation, a password to the AP 14. Upon authentication of the Wi-Fi credentials, the mobile energy control application 11 checks if the energy control website in the IoT Hub 16 is successfully connected to the AP 14. If the Wi-Fi credentials fail, the master smart circuit breaker 1a may reset and send a reset command to the slave smart circuit breakers 1b-1n via the ESP-NOW. At 425, upon successful connection of the AP 14 to the energy control website in the IoT Hub 16, the master smart circuit breaker 1a becomes successfully commissioned to the energy control website and appears on the mobile energy control application 11. At 426, the user can configure the master smart circuit breaker 1a for use via the mobile energy control application 11. For example, the user may provide a designation (e.g., without limitation, a kitchen circuit breaker) for the master smart circuit breaker 1a. Further, the mobile energy control application 11 then creates a list of the smart circuit breakers 1a-1n within its detection range (e.g., without limitation, 2-3 meters) and registers the smart circuit breakers 1a-1n to the energy control website. The BLE connection may be turned off upon the configuration of the master smart circuit breaker 1a.

At Step 3, the slave smart circuit breakers 1b-1n are simultaneously commissioned to the energy control website. Simultaneous commissioning of the slave smart circuit breakers 1b-1n includes: receiving, by the slave smart circuit breakers 1b-1n, the Wi-Fi credentials of the AP 14 from the master smart circuit breaker 1a; and establishing, by the slave smart circuit breakers 1b-1n, a connection to the IoT Hub 16 using a connection string and the Wi-Fi credentials via the mobile energy control application 11. Step 3 includes sub-steps 431-33. At 431, the slave smart circuit breakers 1b-1n receive the Wi-Fi credentials of the AP 14 from the master smart circuit breaker 1a. At 432, the slave smart circuit breakers 1b-1n establish a connection to the IoT Hub 16 using a connection string and the Wi-Fi credentials via the mobile energy control application 11. Upon successful connection to the IoT Hub 16, the slave smart circuit breakers 1b-1n become simultaneously commissioned to the energy control website in the cloud 5. At 433, the slave smart circuit devices 1b-1n appear on the mobile energy control application 11 and the user can configure the slave smart circuit breakers 1b-1n. At 434, if the mobile energy control application 11 fails to register device IDs of all of the smart circuit breakers 1a-1n to the energy control website in the cloud 5, the mobile energy control application 11 may reset the device ID list via the cloud 5 and the commissioning procedure is reinitiated by the user.

At Step 4, the mobile energy control application 11 connects all of the smart circuit breakers 1a-1n to the AP 14, and thus indirectly connect the smart circuit breakers 1a-1n to the energy control website in the IoT Hub 16 via the AP 14. The user can monitor and control the smart circuit breaker 1a-1n via the mobile energy control application 11 remotely.

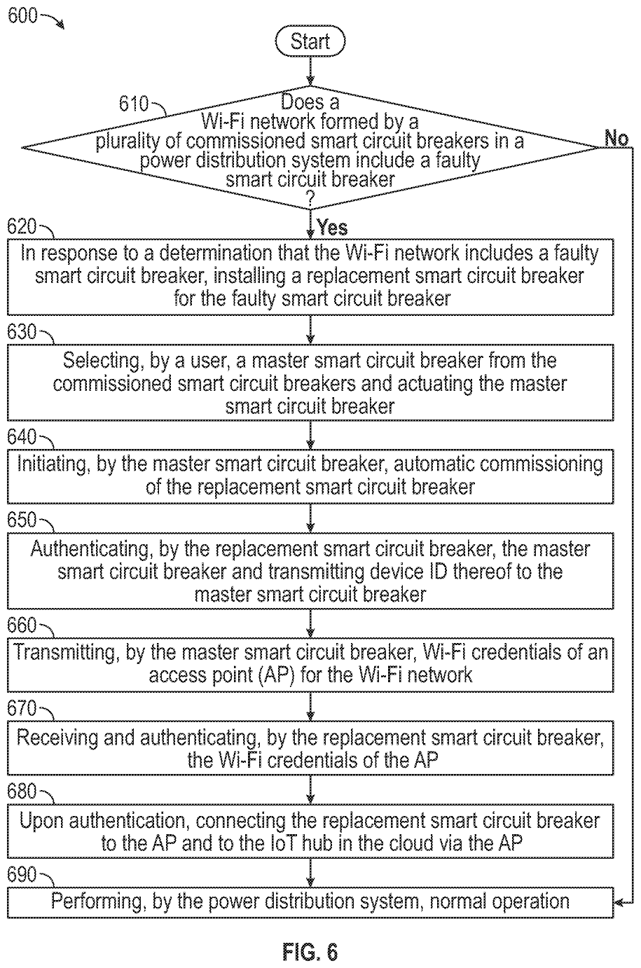

In some examples, a replacement smart circuit breaker for, e.g., without limitation, a faulty smart circuit breaker may be automatically commissioned to the energy control website in the cloud 5 without having to undergo the BLE commissioning with the mobile energy control application 11. FIG. 6 describes in detail adding a replacement smart circuit breaker in the existing Wi-Fi network 103 and commissioning the replacement smart circuit breaker.

In some examples, one or more additional smart circuit breakers may be added to the Wi-Fi network 103. In those examples, Steps 1-4 are performed for commissioning the one or more additional smart circuit breakers.

Accordingly, the inventive simultaneous commissioning method 400,500 allows a plurality of smart circuit breakers 1a-1n to first form a Wi-Fi network 103 without having to connect to the AP 14. The inventive simultaneous commissioning method 400,500 also allows the plurality of smart circuit breakers 1a-1n be commissioned simultaneously, thereby dispensing with the time-consuming and costly one-to-one commissioning procedure required under the conventional Wi-Fi commissioning methods. Further, a replacement smart circuit breaker or a new smart circuit breaker may be automatically commissioned without requiring a field personnel's visit, thereby saving installation costs and time. In addition, if one or more smart circuit breakers are relocated, the user can simply update Wi-Fi credentials of a new AP for the relocated smart circuit breakers, further increasing the efficiency and convenience to the user.

FIG. 5 is a flow chart for a method 500 of simultaneous Wi-Fi commissioning of a plurality of smart circuit breakers in a power distribution system in accordance with a non-limiting, example embodiment of the disclosed concept. The method 500 may be performed by the components of the system 100 of FIG. 1.

At 510, a Wi-Fi network including a plurality of smart circuit breakers is formed.

At 520, a master smart circuit breaker is commissioned to the energy control website in an IoT Hub in a cloud via a mobile energy control application disposed in a mobile user device.

At 530, slave smart circuit breakers are simultaneously commissioned to the energy control website in the IoT Hub in the cloud via the mobile energy control application and the master smart circuit breaker.

At 540, the mobile energy control application connects all of the smart circuit breakers to the AP, which in turn connects the smart circuit breakers to the energy control website in the cloud.

FIG. 6 is a flow-chart for a method 600 of automatically commissioning a replacement smart circuit breaker in a Wi-Fi network including a plurality of smart circuit breakers installed in a power distribution system in accordance with a non-limiting embodiment of the disclosed concept. Each smart circuit breaker is structured to be coupled to a power source and respective loads and provide circuit protection in a fault event, the plurality of breaker having been commissioned simultaneously to an energy control website in an IoT Hub in a cloud upon forming the Wi-Fi network. The method 600 may be performed by the components of the system 100 of FIG. 1.

At 610, it is determined whether the Wi-Fi network includes a faulty smart circuit breaker. If yes, the method 600 proceeds to 620. If no, the method 600 proceeds to 690.

At 620, in response to a determination that the Wi-Fi network includes a faulty smart circuit breaker, a replacement smart circuit breaker for the faulty smart circuit breaker is installed.

At 630, a user selects a master smart circuit breaker from the commissioned smart circuit breakers and actuating the master smart circuit breaker. The user selects an active commissioned smart circuit breaker to act as a master smart circuit breaker and actuates a switch of the master smart circuit breaker to initiate Wi-Fi commissioning procedure of the replacement smart circuit breaker. As such, the mobile energy control application is able to select any smart circuit breaker with active cloud connection and add the replacement smart circuit breaker into the existing setup. The master smart circuit breaker begins ESP-NOW responder and the replacement smart circuit breaker begins ESP-NOW initiator.

At 640, the master smart circuit breaker initiates the automatic commissioning of the replacement smart circuit breaker. The master smart circuit breaker scans for the replacement circuit breaker using ESP-NOW protocol.

At 650, the replacement smart circuit breaker authenticates the master smart circuit breaker and transmits its device ID (i.e., MAC address including a block ID and a device ID) to the master smart circuit breaker.

At 660, the master smart circuit breaker transmits Wi-Fi credentials of an access point (AP) for the Wi-Fi network. The master smart circuit breaker may also send an updated device ID list of all of the smart circuit breakers in the Wi-Fi network to the mobile energy control application. The mobile energy control application then registers the replacement smart circuit breaker and creates an updated list of the smart circuit breakers within its detection range (e.g., without limitation, 2-5 meters).

At 670, the replacement smart circuit breaker receives and authenticates the Wi-Fi credentials of the AP.

At 680, upon authentication, the replacement smart circuit breaker connects to the AP and then to the IoT Hub in the cloud via the AP. The replacement smart circuit breaker appears on the mobile energy control application and the user configures the replacement smart circuit breaker.

At 690, the power distribution system performs normal operation. The power distribution system includes the replacement smart circuit breaker, if any.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A method of simultaneously commissioning a plurality of smart circuit breakers to an energy control website in an IoT (Internet-of-Things) Hub in a cloud, each smart circuit breaker being structured to be coupled to a power source and respective load and provide circuit protection in a fault event, comprising:
forming, by the plurality of smart circuit breakers, a Wi-Fi network, each smart circuit breaker being capable of acting as a master smart circuit breaker;
commissioning a master smart circuit breaker to the energy control website in the IoT Hub via a mobile energy control application disposed in a mobile user device;
simultaneously commissioning slave smart circuit breakers to the energy control website in the cloud via the mobile energy control application and the master smart circuit breaker; and
connecting the master smart circuit breaker and the slave smart circuit breakers to the IoT Hub via an access point (AP).

2. The method of claim 1, wherein the forming, by the plurality of smart circuit breakers, a Wi-Fi network comprises:
installing the plurality of smart circuit breakers in a power distribution system;
actuating a switch on one smart circuit breaker to commence a Wi-Fi network forming procedure;
transmitting, by the one smart circuit breaker, a request to connect;
actuating switches on remaining smart circuit breakers;
transmitting, by the remaining smart circuit breakers, responses to the one smart circuit breaker; and
forming, by the one smart circuit breaker and the remaining smart circuit breakers, the Wi-Fi network based on the responses.

3. The method of claim 2, wherein the remaining smart circuit breakers transmit respective device IDs to the one smart circuit breaker.

4. The method of claim 3, wherein the device IDs are MAC (media-access-control) addresses of the remaining smart circuit breakers.

5. The method of claim 2, wherein the Wi-Fi network forming procedure is performed using ESP-NOW protocol.

6. The method of claim 1, wherein the commissioning a master smart circuit breaker comprises:
selecting a smart circuit breaker to act as the master smart circuit breaker;
actuating a switch on the master smart circuit breaker and placing the master smart circuit breaker in a Bluetooth Low Energy (BLE) mode;
scanning, by the mobile energy control application, for presence of smart circuit breakers in detection range thereof in the BLE mode;
connecting, by the mobile energy control application, to the master smart circuit breaker via a BLE connection;
authenticating Wi-Fi credentials of the AP;
connecting, by the mobile energy control application, the energy control website in the IoT Hub to the AP based on the authentication;
determining, by the mobile energy control application, that the energy control website in the IoT Hub is successfully connected to the AP; and
commissioning the master smart circuit breaker based on the determination that of the energy control website in the IoT Hub is successfully connected to the AP.

7. The method of claim 6, wherein the authenticating the Wi-Fi credentials of the AP comprises:
scanning, by the master smart circuit breaker, Wi-Fi APs in vicinity thereof;
transmitting, by the master smart circuit breaker, a list of the Wi-Fi APs to the mobile energy control application; and
authenticating, by the mobile energy control application, the AP from the list of Wi-Fi APs.

8. The method of claim 7, wherein the Wi-Fi credentials include an SSID and a password for the AP.

9. The method of claim 8, wherein the authenticating, by the mobile energy control application, the AP from the list of Wi-Fi APs includes:
selecting the SSID of the AP; and
entering the password for the AP in the mobile energy control application.

10. The method of claim 6, wherein the commissioning a master smart circuit breaker further comprises:
registering, by the mobile energy control application, the plurality of smart circuit breakers to the energy control website in the IoT Hubs; and
configuring the master smart circuit breaker via the mobile energy control application.

11. The method of claim 10, wherein the registering, by the mobile energy control application, the plurality of smart circuit breakers to the energy control website in the IoT Hub includes:
creating and transmitting, by the master smart circuit breaker, a list of device IDs of the plurality of smart circuit breakers; and
receiving, by the mobile energy control application, the list of device IDs of the plurality of smart circuit breakers.

12. The method of claim 10, wherein the BLE connection is turned OFF upon configuring the master smart circuit breaker via the mobile energy control application.

13. The method of claim 6, wherein in response to a determination that the energy control website is not successfully connected to the AP, the master smart circuit breaker resets and sends a reset command to the slave smart circuit breakers via ESP-NOW protocol.

14. The method of claim 1, wherein the simultaneously commissioning slave smart circuit breakers comprises:
receiving, by the slave smart circuit breakers, the Wi-Fi credentials of the AP from the master smart circuit breaker; and
establishing, by the slave smart circuit breakers, a connection to the IoT Hub using a connection string and the Wi-Fi credentials via the mobile energy control application.

15. The method of claim 14, wherein the simultaneously commissioning slave smart circuit breakers further comprises:
configuring the slave smart circuit breakers via the mobile energy control application.

16. The method of claim 14, wherein the slave smart circuit breakers are not commissioned to the energy control website in the IoT Hub at one slave smart circuit breaker at a time.

17. A method of automatically commissioning a replacement smart circuit breaker in a Wi-Fi network including a plurality of smart circuit breakers structured to be coupled to a power source and respective loads and provide circuit protection in a fault event, the plurality of breaker having been commissioned simultaneously to an energy control website in an IoT Hub in a cloud upon forming the Wi-Fi network, the method comprising:
determining that the Wi-Fi network includes a faulty smart circuit breaker;
in response to the determination that the Wi-Fi network includes a faulty smart circuit breaker, installing a replacement smart circuit breaker for the faulty smart circuit breaker;
selecting a master smart circuit breaker from the commissioned smart circuit breakers and actuating the master smart circuit breaker;
initiating, by the master smart circuit breaker, the automatic commissioning of the replacement smart circuit breaker;
authenticating, by the replacement smart circuit breaker, the master smart circuit breaker and transmitting a device ID thereof to the master smart circuit breaker;
transmitting, by the master smart circuit breaker, Wi-Fi credentials of an access point for the Wi-Fi network;
authenticating, by the replacement smart circuit breaker, the Wi-Fi credentials; and
connecting, by the replacement smart circuit breaker, to the AP and to the energy control website in the IoT using the Wi-Fi credentials.

18. The method of claim 17, wherein initiating, by the master smart circuit breaker, the automatic commissioning of the replacement smart circuit breaker includes scanning for the replacement circuit breaker.

19. The method of claim 18, wherein the scanning for the replacement circuit breaker is performed using ESP-NOW protocol.

20. A system, comprising:
a plurality of smart circuit breakers structured to be coupled to a power source and respective loads and provide circuit protection during a fault event;
a mobile energy control application disposed in a mobile user device;
an IoT (Internet-of-Things) Hub disposed in the cloud and communicatively coupled to the mobile energy control application, the IoT Hub including the energy control website; and
an access point (AP) structured to be connected to the plurality of smart circuit breakers and the IoT Hub, wherein the plurality of smart circuit breakers are commissioned to the energy control website using a simultaneous Wi-Fi commissioning procedure comprising:
forming, by the plurality of smart circuit breakers, a Wi-Fi network, each smart circuit breaker being capable of acting as a master smart circuit breaker;
commissioning a master smart circuit breaker to the energy control website in the IoT Hub via the mobile energy control application;
simultaneously commissioning slave smart circuit breakers to the energy control website via the mobile energy control application and the master smart circuit breaker; and
connecting the master smart circuit breaker and the slave smart circuit breakers to the AP and to the energy control website in the IoT Hub via the AP.
